(19) United States
(12) Patent Application Publication
(10) Pub. No.: US 2023/0142452 A1
(43) Pub. Date: May 11, 2023

(54) DATA PROCESSING METHOD, DATA PROCESSING DEVICE, AND DATA PROCESSING PROGRAM

(71) Applicant: NIPPON TELEGRAPH AND TELEPHONE CORPORATION, Tokyo (JP)

(72) Inventor: Yasutoshi IDA, Musashino-shi, Tokyo (JP)

(73) Assignee: NIPPON TELEGRAPH AND TELEPHONE CORPORATION, Tokyo (JP)

(21) Appl. No.: 17/917,560

(22) PCT Filed: Apr. 27, 2020
(86) PCT No.: PCT/JP2020/018013

§ 371 Date: Oct. 7, 2022

(51) Int. Cl. G06F 17/16

(52) U.S. Cl. CPC G06F 17/16

(57) ABSTRACT

A data processing apparatus includes a lower bound calculation unit that calculates, in search of a hyperparameter, based on a norm of each row or column of a gram matrix to be processed, a lower bound of an optimal condition value when a solution of a parameter vector corresponding to the row or column is a zero vector, and an important matrix determination unit that determines whether the row or column is important. Further, there is an important matrix extraction unit that extracts the row or column determined to be important, an important matrix updating unit that updates a parameter corresponding to the row or column determined to be important. Also, there is an upper bound calculation unit that calculates an upper bound of the optimal condition value corresponding to the rows or columns to be processed, a calculation omission determination unit, and an updating calculation unit.

### TECHNICAL FIELD

The present invention relates to a data processing method, a data processing apparatus, and a data processing program.

### BACKGROUND ART

Matrix decomposition is a basic technology in data analysis and machine learning. In many matrix decompositions, a matrix is decomposed into a plurality of matrices to perform dimensionality reduction or low-rank approximation, such as singular value decomposition.

Among them, CUR matrix decomposition (see, for example, NPL 1) is drawing attention because of its high interpretability of the decomposed matrix. This is because in the CUR matrix decomposition, rows and columns of the decomposed matrix are subsets of rows and columns of an original matrix before decomposition. That is, in the CUR matrix decomposition, the decomposed matrix is a submatrix of the original matrix, and original data is preserved also after the decomposition, so that it is easy to interpret the matrix even for human eyes. This property of the CUR matrix decomposition is a property not found in other matrix decompositions such as singular value decomposition. The CUR matrix decomposition is often used to regard rows and columns of a decomposed matrix as important rows and columns and to extract important rows and columns from matrix data.

As described in NPL 1, in the CUR matrix decomposition, a solving approach using a randomized algorithm is common. However, in the method described in NPL 1, a result changes every time due to randomization, and an error tends to be large when a decomposed matrix is small. Thus, a deterministic algorithm has been proposed in order to deal with this tendency (see, for example, NPL 2).

In the method described in NPL 2, a problem of the CUR matrix decomposition is formulated as a convex optimization problem with sparse regularization, and a solution thereof is obtained by repeatedly updating parameters of an objective function thereof using an algorithm called coordinate descent.

Specifically, in the method described in NPL 2, a parameter vector corresponding to the rows and columns of the matrix is introduced into the objective function, and in the coordinate descent, this parameter vector is updated in order until the parameter vector converges for each row and column so that the objective function becomes smaller. In this case, the parameter vector tends to be a zero vector due to an effect of sparse regularization. Because rows and columns corresponding to the parameter vectors that have become zero vectors can be regarded as unimportant rows and columns in the objective function, important rows and columns can be extracted from the original matrix.

In other words, the coordinate descent updates the parameter vectors in order for respective rows and columns and repeats the update until all the parameter vectors converge. Ultimately, rows and columns that become zero vectors are unimportant rows and columns, and rows and columns in which parameter vectors become non-zero vectors can be said to be important rows and columns.

However, the coordinate descent of the CUR matrix decomposition has a problem that calculation is slow for large-scale data. This is because, in the coordinate descent of the CUR matrix decomposition, when the number of rows of a matrix is n and the number of columns is p, time complexity of O(p²) or O(np) is required for two updating calculations of the parameter vectors. Further, this is because, in the coordinate descent of the CUR matrix decomposition, this updating calculation must be repeated until all parameter vectors converge. Thus, it is difficult to apply the CUR matrix decomposition to large-scale data.

There are not many studies dealing with an increase in speed of the coordinate descent of the CUR matrix decomposition, but it is possible to increase the speed by using safe screening (see, for example, NPL 3). With safe screening, it is possible to specify and delete rows and columns in which the parameter vectors become zero vectors before the coordinate descent is applied.

### CITATION LIST

### Non Patent Literature

NPL 1: Michael W. Mahoney, and Petros Drineas, “CUR matrix decompositions for improved data analysis”, Proc. Natl. Acad. Sci. U.S.A., 106(3): 697-702, 2009.

NPL 2: J. Bien, Y. Xu, and M. W. Mahoney, “CUR from a Sparse Optimization Viewpoint”, In NeurIPS, pp. 217-225, 2010.

NPL 3: E. Ndiaye, O. Fercoq, A. Gramfort, and J. Salmon, “Gap Safe Screening Rules for Sparsity Enforcing Penalties”, Journal of Machine Learning Research, 18(1): 4671-4703, 2017.

### SUMMARY OF THE INVENTION

### Technical Problem

However, when the number of rows and columns that can be deleted by safe screening is small, there is a problem that a speed of the coordinate descent is not increased. In particular, it is theoretically known in the safe screening that it is difficult to delete rows and columns when an initial value of the parameter vector is far from a solution.

The present invention has been made in view of the above, and an object of the present invention is to provide a data processing apparatus, a data processing method, and a data processing program for increasing a speed of coordinate descent in order to apply CUR matrix decomposition to large-scale data.

### Means for Solving the Problem

In order to solve the above-described problem and achieve the object, a data processing method according to the present invention is a data processing method executed by a data processing apparatus for extracting important rows or columns from matrix data, the data processing method including calculating norms of rows or columns of a gram matrix of given data, calculating, in search of a hyperparameter, based on a norm of a row or column to be processed, a lower bound of a determination value of an optimal condition when a solution of a parameter vector corresponding to the row or column to be processed is a zero vector, determining whether the row or column to be processed is important based on the lower bound, to extract the row or column that is determined to be important, updating a parameter corresponding to the row or column that is determined to be important, calculating an upper bound of the determination value of the optimal condition when the solution of the parameter vector corresponding to the row or column to be processed is the zero vector, and determining whether parameter updating for the row or column to be processed is necessary based on the upper bound, to perform the parameter updating when the parameter updating is determined to be necessary.

Further, a data processing apparatus according to the present invention is a data processing apparatus for extracting important rows or columns from matrix data, the data processing apparatus including a first calculation unit that calculates norms of rows or columns of a gram matrix of given data, a second calculation unit that calculates, in search of a hyperparameter, based on a norm of a row or column to be processed, a lower bound of a determination value of an optimal condition when a solution of a parameter vector corresponding to the row or column to be processed is a zero vector, a first determination unit that determines whether the row or column to be processed is important based on the lower bound, an extraction unit that extracts the row or column that is determined to be important by the important matrix determination unit, a first updating unit that updates a parameter corresponding to the row or column that is determined to be important, a third calculation unit that calculates an upper bound of the determination value of the optimal condition when the solution of the parameter vector corresponding to the row or column to be processed is the zero vector, a second determination unit that determines whether parameter updating for the row or column to be processed is necessary based on the upper bound, and a second updating unit that performs the parameter updating when the parameter updating is determined to be necessary by the second determination unit.

Further, a data processing program according to the present invention causes a computer to execute calculating norms of rows or columns of a gram matrix of given data, calculating, in search of a hyperparameter, based on a norm of a row or column to be processed, a lower bound of a determination value of an optimal condition when a solution of a parameter vector corresponding to the row or column to be processed is a zero vector, determining whether the row or column to be processed is important based on the lower bound, to extract the row or column that is determined to be important, updating a parameter corresponding to the row or column that is determined to be important, calculating an upper bound of the determination value of the optimal condition when the solution of the parameter vector corresponding to the row or column to be processed is the zero vector, and determining whether parameter updating for the row or column to be processed is necessary based on the upper bound, to perform the parameter updating when the parameter updating is determined to be necessary.

### Effects of the Invention

According to the present invention, it is possible to increase a speed of coordinate descent in order to apply CUR matrix decomposition to large-scale data.

### BRIEF DESCRIPTION OF DRAWINGS

FIG. 1 is a block diagram illustrating an example of a configuration of a data processing apparatus according to an embodiment.

FIG. 2 is a diagram illustrating a pseudo code of coordinate descent.

FIG. 3 is a diagram illustrating an example of an algorithm used by the data processing apparatus illustrated in FIG. 1.

FIG. 4 is a flowchart illustrating a processing procedure of data processing according to an embodiment.

FIG. 5 is a diagram illustrating an example of a computer in which a data processing apparatus is implemented by a program being executed.

### DESCRIPTION OF EMBODIMENTS

Hereinafter, an embodiment of the present invention will be described in detail with reference to the drawings. The present invention is not limited to this embodiment. Further, in description of the drawings, the same parts are denoted by the same reference signs.

Hereinafter, for A that is a vector, matrix, or scalar, “ A” is assumed to be equivalent to “the symbol ‘ ’ written directly above ‘A’”. Further, for A that is a vector, matrix, or scalar, “_A” is assumed to be equivalent to “the symbol ‘_’ written directly under ‘A’”. Further, for A that is a vector, matrix, or scalar, “˜A” is assumed to be equivalent to “the symbol ‘˜’ is written directly above ‘A’”. Further, for A that is a vector or matrix, A^{T} indicates a transposition of A.

### Embodiment

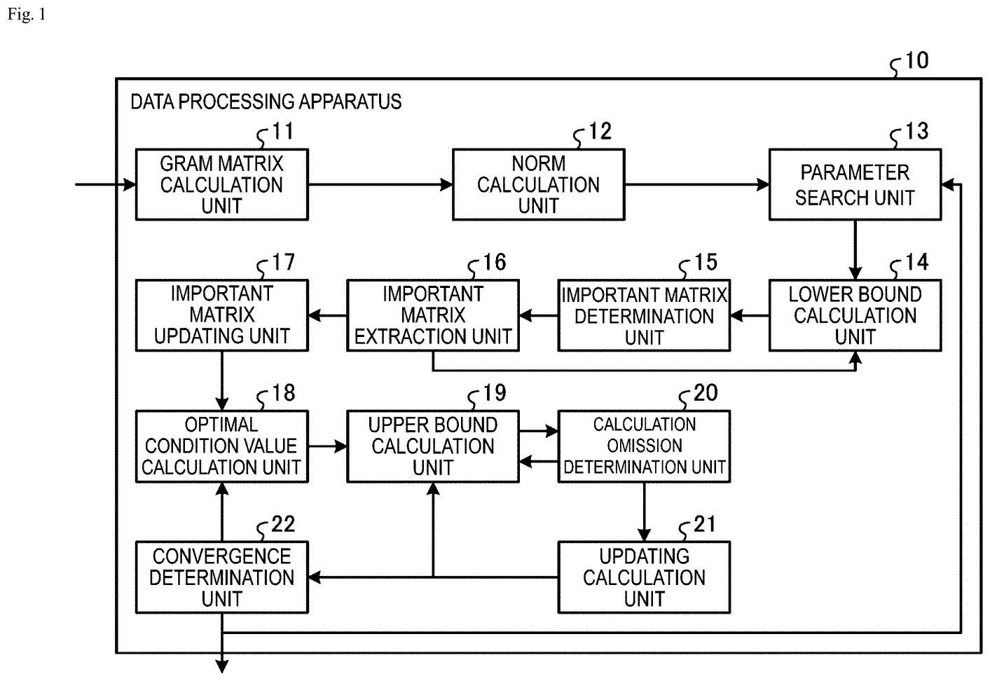

First, the present embodiment will be described. FIG. 1 is a block diagram illustrating an example of a configuration of a data processing apparatus according to the embodiment.

A data processing apparatus 10 according to the present embodiment illustrated in FIG. 1 is a CUR matrix decomposition data processing apparatus that extracts important rows or columns from matrix data. The data processing apparatus 10 includes a gram matrix calculation unit 11, a norm calculation unit 12 (first calculation unit), a parameter search unit 13, a lower bound calculation unit 14 (second calculation unit), an important matrix determination unit 15 (first determination unit), an important matrix extraction unit 16 (extraction unit), an important matrix updating unit 17 (first updating unit), an optimal condition value calculation unit 18, an upper bound calculation unit 19 (third calculation unit), a calculation omission determination unit 20 (second determination unit), an updating calculation unit 21 (second updating unit), and a convergence determination unit 22. The data processing apparatus 10 is implemented, for example, by a predetermined program being read into a computer including a read only memory (ROM), a random access memory (RAM), a central processing unit (CPU), and the like and the CPU executing the predetermined program.

The gram matrix calculation unit 11 calculates a gram matrix of given data. The norm calculation unit 12 calculates a norm for each row or column of the gram matrix. The parameter search unit 13 searches for hyperparameters. The lower bound calculation unit 14 calculates a lower bound of the determination value (optimal condition value) of the optimal condition when a solution of a parameter vector corresponding to the row or column to be processed is a zero vector, based on the norm for each row or column to be processed. The important matrix determination unit 15 determines whether the row or column is important based on the lower bound of the determination value of the optimal condition. The important matrix extraction unit 16 extracts the row or column determined to be important. The important matrix updating unit 17 mainly updates a parameter corresponding to the extracted important row or column.

The optimal condition value calculation unit 18 calculates the determination value of the optimal condition when the solution of the parameter vector corresponding to the row or column to be processed is a zero vector. The upper bound calculation unit 19 calculates an upper bound of the optimal condition value when the solution of the parameter vector corresponding to the row or column to be processed is the zero vector. The calculation omission determination unit 20 determines whether parameter updating is necessary for the row or column to be processed based on the upper bound of the determination value of the optimal condition. The updating calculation unit 21 performs updating when updating is necessary. The convergence determination unit 22 determines convergence of the parameter vector.

Because the data processing apparatus 10 omits unnecessary calculations in CUR matrix decomposition and preferentially performs important calculations, it can execute the CUR matrix decomposition at a high speed and extract important rows or columns from the matrix data at a high speed.

Mathematical Background

The CUR matrix decomposition and the coordinate descent will be described herein as background knowledge.

The CUR matrix decomposition is a scheme for decomposing data in a matrix format into a plurality of matrices. When n is the number of pieces of data and each piece of data is expressed by a p-dimensional feature quantity, the data in a matrix format can be expressed by a matrix X∈R^{n×p}.

The CUR matrix decomposition decomposes X into three matrices as shown in Expression (1). Sizes of the respective matrices are C∈R^{n×c}, U∈R^{c×r}, and R∈R^{r×p}.

[Math. 1]

X≈CUR (1)

Here, C includes c column vectors in X. R includes r row vectors. C and R are submatrices of X, and can be said to be highly important column vector and row vector for approximating X.

Under this setting, a deterministic algorithm for CUR matrix decomposition solves an optimization problem with sparse regularization to extract C and R. Here, the optimization problem for extracting C is described as in Expression (2) for simplicity.

$$\begin{matrix}[ Math . 2 ] & \\ {min}_{W ∈ {R}^{p \times p}} \frac{1}{2} ‖ X - XW ‖ {\vert}_{F}^{2} + λ {{\sum }_{i = 1}}^{p} {‖ {W}_{( i )} ‖}_{2} & ( 2 )\end{matrix}$$

In Expression (2), W∈R^{p×p} is a parameter that is an optimization target. ∥•∥²_{F} is a Frobenius norm. λ≥0 is a hyperparameter and is a target for manual tuning. W₍ᵢ₎ is an i-th row vector of W.

In Expression (2), ∥W₍ᵢ₎∥₂ is a norm (constraint term) for inducing sparseness, and by solving an optimization problem with this norm, it becomes easy for W₍ᵢ₎ to become a zero vector. Further, a term shown in Expression (3) in Expression (2) is an error function, and optimization is performed so that an error between X and XW becomes small.

$$\begin{matrix}[ Math . 3 ] & \\ \frac{1}{2} {‖ X - XW ‖}_{F}^{2} & ( 3 )\end{matrix}$$

A row vector of W includes many zero vectors due to an influence of the constraint term as a result of optimization, but in this case, an index of rows that are non-zero vectors is I⊆{1, . . . , p}. Then, XW contributing to minimization of the error function becomes substantiality X^{I}W_{I}. Here, X^{I} is a matrix consisting of a column vector of X corresponding to an index I. W_{I} is a matrix consisting of the row vectors of W corresponding to the index I. C=X^{I} is set so that C can be extracted. A method of simultaneously extracting C and R will be described below.

Next, coordinate descent will be described. The coordinate descent is an algorithm for solving an optimization problem of Expression (2). Specifically, W₍ᵢ₎ is repeatedly updated for each row until the whole W converges so that a solution of the optimization problem of Expression (2) is obtained. When ∥W₍ᵢ₎∥₂=1, an updating equation for W₍ᵢ₎ is given as in Equation (4) below.

[Math. 4]

W₍ᵢ₎=(1−λ/∥zᵢ∥₂)₊zᵢ (4)

In Equation (4), (1−λ/∥zᵢ∥₂)₊ is calculated as in Equation (5).

$$\begin{matrix}[ Math . 5 ] & \\ {( 1 - λ / {‖ {z}_{i} ‖}_{2} )}_{+} = \{ \begin{matrix}1 - λ / {‖ {z}_{i} ‖}_{2} , if 1 - λ / {‖ {z}_{i} ‖}_{2} > 0 \\ 0 , otherwise .\end{matrix} & ( 5 )\end{matrix}$$

In Equation (4), zᵢ ∈R^{l×p} is calculated as in Equation (6).

[Math. 6]

zᵢ=X^{(i)T}(X−Σ_{j≠i}^{p}X^{(j)}W₍ⱼ₎) (6)

X⁽ⁱ⁾ indicates an i-th column vector of X.

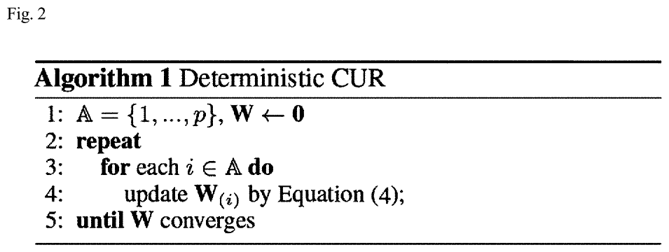

FIG. 2 is a diagram illustrating a pseudo code of coordinate descent using Equation (4). Algorithm 1 initializes W in row number 1 of FIG. 2, and then applies the updating equation (4) to each row (row numbers 3 and 4; internal loop). In algorithm 1, this is repeated until the whole W converges (row numbers 2 to 5).

Here, in calculation of Equation (4), large time complexity of O(p²n) is required. For Equation (4), calculation can be devised for O(p²) or O(pn), but a calculation cost is still large for a large data matrix X.

Mathematical Background in Embodiment

Next, a mathematical background in the embodiment will be described. The present embodiment is for increasing a speed of the coordinate descent of the CUR matrix decomposition, and includes the following two ideas.

The first idea is to specify the rows in which W₍ᵢ₎ is a zero vector with low computational complexity (O(p)), and omit updating calculation of Equation (4), which is a bottleneck of the coordinate descent, for such rows.

A second idea is to specify rows in which W₍ᵢ₎ is always a non-zero vector and update rows preferentially from such rows. In the present embodiment, an increase in speed is achieved by the first idea and the second idea.

Specifically, a condition (optimal condition) when W₍ᵢ₎=0 becomes an optimal value is approximately evaluated so that the first idea and the second idea are achieved. The optimal condition when W₍ᵢ₎=0 is an optimal value is illustrated in Expression (7) below using an optimal condition value Kᵢ=∥zᵢ∥₂.

[Math. 7]

Kᵢ≤λ (7)

It can be said that W₍ᵢ₎=0 when the condition of Expression (7) is satisfied.

When a condition shown in Expression (7) is evaluated, it can be confirmed whether the row is a zero vector. That is, when the condition shown in Expression (7) is satisfied, the row can be said to be a zero vector without executing Equation (4), so that Equation (4) can be skipped and the first idea can be achieved. In addition, when the condition shown in Expression (7) is not satisfied, the row can be said to be a non-zero vector, so that the second idea can be achieved.

Here, time complexity required for evaluation of the condition shown in Expression (7) is as large as O(p²) or O(pn). Thus, in the present embodiment, the condition shown in Expression (7) is approximately evaluated so that the computational complexity is reduced. Specifically, in the present embodiment, an upper bound Kᵢ and a lower bound _Kᵢ are evaluated instead of the optimal condition value Kᵢ. The upper bound Kᵢ is an upper bound of the determination value of the optimal condition when a solution of a parameter vector corresponding to a certain row or column is a zero vector. The lower bound _Kᵢ is the lower bound of the determination value of the optimal condition when the solution of the parameter vector corresponding to a certain row or column is a zero vector. The upper bound Kᵢ and the lower bound _Kᵢ are given as in Equations (8) and (9), respectively.

[Math. 8]

K̅ᵢ̅=\tilde{K}ᵢ+∥ΔW₍ᵢ₎∥₂+∥G₍ᵢ₎∥₂∥ΔW∥_{F} (8)

[Math. 9]

Kᵢ=\tilde{K}ᵢ−∥ΔW₍ᵢ₎∥₂−∥G₍ᵢ₎∥₂∥ΔW∥_{F} (9)

Here, ˜Kᵢ is an optimal condition value immediately before entrance to the internal loop. In Equations (8) and (9), when ˜W is W immediately before entrance to the internal loop, ΔW₍ᵢ₎=W₍ᵢ₎−˜W₍ᵢ₎ and ΔW=W−˜W. Further, G₍ᵢ₎ ∈R^{l×p} indicates an i-th row vector of G=X^{T}X∈R^{p×p}. Expressions (10) and (11) are satisfied for Equations (8) and (9), respectively.

[Math. 10]

K̅ᵢ̅≥Kᵢ (10)

[Math. 11]

Kᵢ≤Kᵢ (11)

In the present embodiment, a determination is made whether the updating calculation of Equation (4) is omitted by using the upper bound in order to achieve the first idea described above. Further, in the present embodiment, the lower bound is used to specify rows that become non-zero vectors, and the updates are performed preferentially from such rows in order to achieve the second idea.

Using the upper bound Kᵢ, rows that become the zero vectors can be specified and the first idea can be achieved. Specifically, when Expression (12) is satisfied, W₍ᵢ₎ is a zero vector.

[Math. 12]

K̅ᵢ̅≤λ (12)

This is because the condition shown in Expression (7) is satisfied because Expression (13) is satisfied.

[Math. 13]

Kᵢ≤K̅ᵢ̅≤λ (13)

However, Equation (8) still requires the time complexity of O(p²). Thus, in the present embodiment, Equation (8) is modified and the computational complexity is reduced. Specifically, the upper bound Kᵢ is calculated online (sequentially) when a certain W₍ⱼ₎ is updated to W′₍ⱼ₎, using Equation (14) below.

[Math. 14]

K̅ᵢ̅=\acute{K}ᵢ+∥ΔW₍ᵢ₎∥₂+δ∥G₍ᵢ₎∥₂ (14)

In Equation (14), δ is Equation (15).

[Math. 15]

δ=\sqrt{∥ΔW∥_{F}²−∥ΔW₍ⱼ₎∥₂²+∥ΔW′₍ⱼ₎∥₂²} (15)

the time complexity of Equation (14) is O(p), which is a sufficiently low computational complexity. Thus, when the upper bound Kᵢ is calculated using Equation (14), and a condition shown in Expression (12) is satisfied, W₍ᵢ₎ can be determined to be a zero vector and thus, in this case, Equation (4) can be omitted so that the first idea can be achieved. When the condition shown in Expression (12) is not satisfied. W₍ᵢ₎ is updated in Equation (4) as usual.

By using the lower bound _Kᵢ, the row that becomes a non-zero vector can be specified and the second idea can be achieved. Specifically, when Expression (16) is satisfied, W₍ᵢ₎ is a non-zero vector.

[Math. 16]

Kᵢ>λ (16)

This is because the condition shown in Expression (7) is not satisfied because Expression (17) is satisfied.

[Math. 17]

Kᵢ≥Kᵢ>λ (17)

The second idea is to preferentially update the parameters for such rows that become non-zero vectors. Thus, a set in which only rows that become non-zero vectors are collected is formed as shown in Equation (18) below in order to preferentially update rows that becomes non-zero vectors.

[Math. 18]

M={i∈{1, . . . ,p}|Kᵢ>λ} (18)

Further, it is possible to reduce the computational complexity of Equation (9) for the lower bound by reusing a term of the calculation of the upper bound by Equation (14). Specifically, the lower bound is calculated using Equation (19) below.

[Math. 19]

Kᵢ=K̅ᵢ̅−2∥ΔW₍ᵢ₎∥₂−2δ∥G₍ᵢ₎∥₂ (19)

When the term calculated by Equation (14) is reused, the computational complexity in Equation (19) becomes O(1), which is a sufficiently low computational complexity. The second idea is achieved by first executing the coordinate descent by using only rows corresponding to a set M.

Thus, in the present embodiment, first, only the rows corresponding to the set M are used to execute the coordinate descent until it converges (second idea). Then, in the present embodiment, all the rows are used to execute the coordinate descent, but at this time, the upper bound is used to perform updating while safely omitting unnecessary calculations (first idea). Thus, in the present embodiment, because necessary calculations are not omitted, convergence to a value of the same objective function as the original coordinate descent occurs.

Processing Procedure of Data Processing

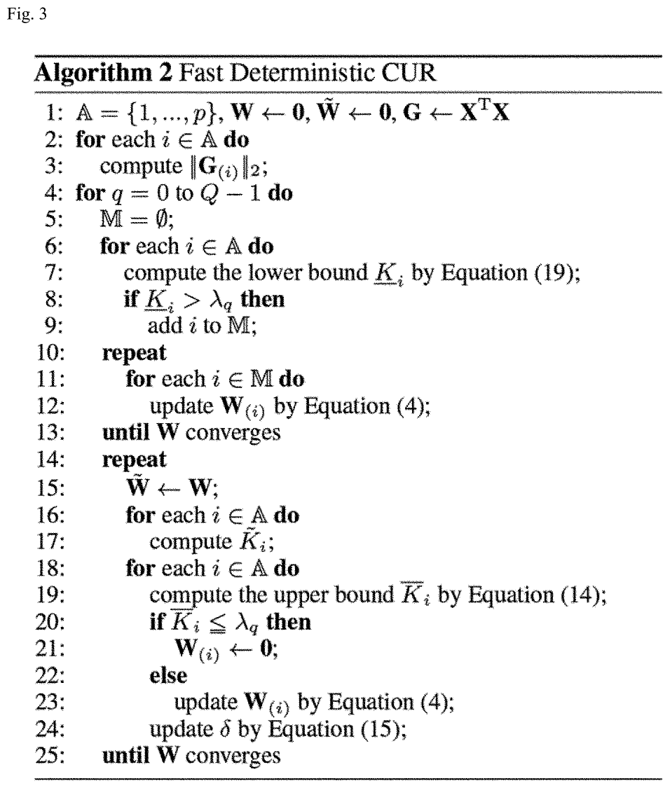

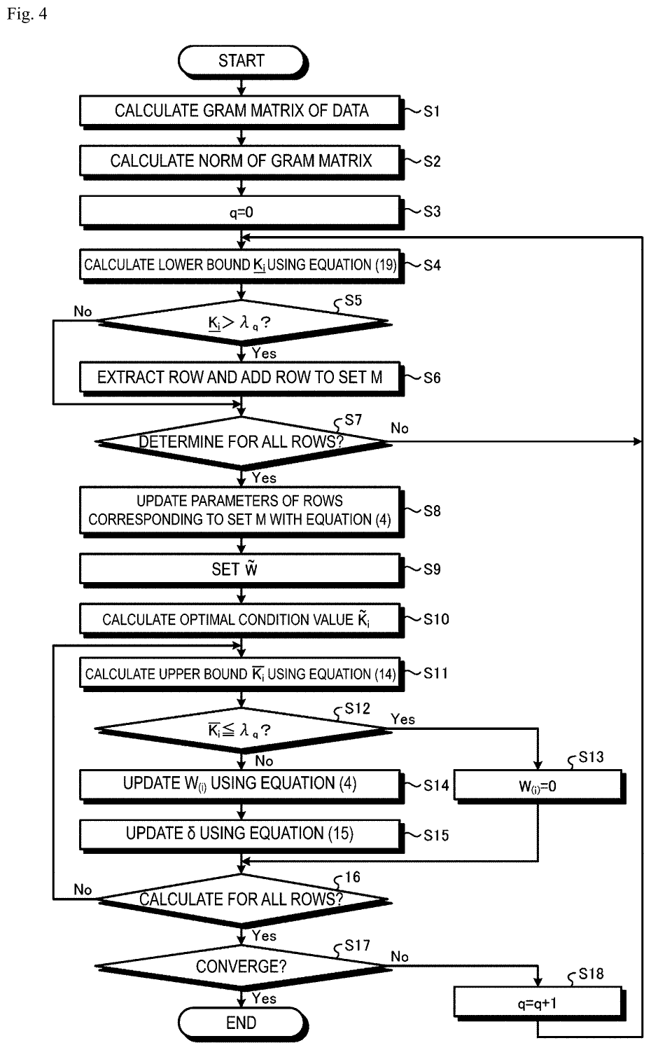

Next, a processing procedure for data processing executed by the data processing apparatus 10 according to the present embodiment will be described. FIG. 3 is a diagram illustrating an example of an algorithm used by the data processing apparatus 10 illustrated in FIG. 1. FIG. 4 is a flowchart illustrating a processing procedure of data processing according to the embodiment.

The gram matrix calculation unit 11 calculates a gram matrix G of given data (row number 1 in FIG. 3 and step S1 in FIG. 4). Calculation of the gram matrix G is performed. The norm calculation unit 12 calculates a norm ∥G₍ᵢ₎∥₂ for each row or column of the gram matrix used for the calculation of the upper and lower bounds (row numbers 2 and 3 in FIG. 3 and step S2 in FIG. 4).

Subsequently, the data processing apparatus 10 performs search for a hyperparameter λ (loop of row numbers 4 to 25 in FIG. 3). Row numbers 4 to 25 in FIG. 3 indicate loop processing of the parameter search unit 13, and the data processing apparatus 10 performs the CUR matrix decomposition many times while changing λ, which is a hyperparameter in Expression (2) for the CUR matrix decomposition, from λ₀ to λ_{Q-1}. First, the parameter search unit 13 initializes an index q (0≤q≤Q−1) of λ to 0 (step S3 in FIG. 4).

The lower bound calculation unit 14 calculates the lower bound _Kᵢ of the determination value of the optimal condition when the solution of the parameter vector corresponding to the row to be processed is a zero vector by using Equation (19) (row number 7 in FIG. 3 and step S4 in FIG. 4). The important matrix determination unit 15 compares the lower bound _Kᵢ with λ_{q} to determine whether Expression (16) is satisfied (row number 8 in FIG. 3 and step S5 in FIG. 4), thereby determining the row that is a non-zero vector. When Expression (16) is satisfied (step S5 in FIG. 4: Yes), the important matrix extraction unit 16 extracts this row as a row that becomes a non-zero vector and adds the row to the set M (row number 9 in FIG. 3 and step S6 in FIG. 4).

After step S6 in FIG. 4 ends or when Expression (16) is not satisfied (step S5 in FIG. 4: No), the important matrix extraction unit 16 determines whether step S5 has been performed on all rows (step S7 in FIG. 4). When step S5 of FIG. 4 is not performed on all rows (step S7 in FIG. 4: No), the data processing apparatus 10 returns to step S4 in FIG. 4 and the lower bound calculation unit 14 calculates the lower bound for the row as a next processing target.

When step S5 is performed on all rows (step S7 in FIG. 4: Yes), the important matrix updating unit 17 updates parameters of the rows corresponding to the set M with Equation (4) until the parameters converge (row numbers 11 and 12 in FIG. 3 and step S8 in FIG. 4). Thus, the data processing apparatus 10 preferentially updates parameters of a set in which only the rows that become the non-zero vectors are collected.

Subsequently, the data processing apparatus 10 performs loop processing of coordinate descent by using the upper bound Kᵢ (row numbers 14 to 25 in FIG. 3). First, in the data processing apparatus 10, another ˜W immediately before entrance to the internal loop is set (row number 15 in FIG. 3 and step S9 in FIG. 4). The optimal condition value calculation unit 18 calculates the optimal condition value ˜Kᵢ of each row i (row numbers 16 and 17 in FIG. 3 and step S10 in FIG. 4).

The upper bound calculation unit 19 calculates the upper bound Kᵢ of the optimal condition value for the row i to be processed by using Equation (14) (row number 19 in FIG. 3 and step S11 in FIG. 4). The calculation omission determination unit 20 compares the upper bound Kᵢ with λ_{q} to determine whether Kᵢ≤λ_{q} is satisfied (row number 20 in FIG. 3 and step S12 in FIG. 4).

When Kᵢ≤λ_{q} is satisfied (step S12 in FIG. 4: Yes), the calculation omission determination unit 20 sets W₍ᵢ₎=0 and omits updating calculation for this row (row number 21 in FIG. 3 and step S13 in FIG. 4).

On the other hand, when Kᵢ≤λ_{q} is not satisfied (step S12 in FIG. 4: No), the updating calculation unit 21 updates W₍ᵢ₎ by using Equation (4) for this row (row number 23 in FIG. 3 and step S14 in FIG. 4). In this case, the updating calculation unit 21 updates δ by using Equation (15) in order to perform online update the upper and lower bounds (Equations (14) and (19)) (row number 24 in FIG. 3 and step S15 in FIG. 4). The calculation omission determination unit 20 determines whether the upper bound has been calculated for all the rows (step S16). When the upper bound has not been calculated for all rows (step S16: No), the processing returns to step S11 and the upper bound calculation unit 19 calculates the upper bound for the next row.

On the other hand, when the upper bound is calculated for all rows (step S16 in FIG. 4: Yes), the convergence determination unit 22 determines whether all parameters have converged (step S17 in FIG. 4). The convergence determination unit 22 determines whether the search has ended for all parameters from λ₀ to λ_{Q-1}. When all parameters have not converged (step S17 in FIG. 4: No), the parameter search unit 13 sets the index q of λ to q+1 (step S18 in FIG. 4) and returns to step S4.

The data processing apparatus 10 ends the processing when all parameters have converged (step S17 in FIG. 4: Yes).

### Effects of Embodiment

As described above, in the present embodiment, a determination whether the parameter vector becomes a zero vector is made with low computational complexity before the updating calculation for the parameter vector, which is a bottleneck of the coordinate descent, is performed, and when the parameter vector becomes a zero vector, the updating calculation is omitted. Thus, in the present embodiment, it is possible to increase the speed of coordinate descent. Further, in the present embodiment, the parameter vectors that become non-zero vectors are specified in advance and are updated preferentially and intensively.

Thus, according to the present embodiment, the speed of the coordinate descent can be increased so that the speed of extraction of important rows and columns based on the CUR matrix decomposition can be increased. In the present embodiment, updating calculation for rows and columns that become a zero vector is safely omitted, and rows and columns that become a non-zero vector are mainly updated. Thus, in the present embodiment, because it can be guaranteed that the objective function value as a result of the optimization according to the present embodiment matches the original coordinate descent, it is possible to accurately execute the CUR matrix decomposition and extract important rows and columns.

Thus, according to the present embodiment, because the speed of coordinate descent can be accurately increased, the CUR matrix decomposition can be applied to large-scale data.

### Modification Example

So far, description has been given using an example in which C is extracted. In the present modification example, an extension method for simultaneously extracting C and R will be described. In the extraction of C, the optimization problem of Expression (2) is solved, but in the simultaneous extraction of C and R, an optimization problem illustrated in Expression (20) below is solved.

$$\begin{matrix}[ Math . 20 ] & \\ {min}_{W ∈ {R}^{p \times n}} \frac{1}{2} {‖ X - XWX ‖}_{F}^{2} + {λ}_{r} {{\sum }_{i = 1}}^{p} {‖ {V}_{( i )} ‖}_{2} + {λ}_{c} {{\sum }_{j = 1}}^{n} {‖ {H}^{( j )} ‖}_{2} & ( 20 )\end{matrix}$$

V∈R^{p×n}, H∈R^{p×n}, and W is expressed by W=V+H. Σ^{p}ᵢ₌₁∥V₍ᵢ₎∥₂ and Σⁿⱼ₌₁∥H^{(j)}∥₂ are constraint terms that make it easy for a row vector and a column vector to become zero vectors, respectively. λᵣ and λ_{c} are hyperparameters for controlling strength of the constraint.

C and R are extracted by using the same scheme as described above in correspondence to indexes of non-zero vectors of V and H, respectively. Because there are two variables V and H, two types of coordinate descent are also executed in correspondence to V and H. The optimal condition values when V and H take zero vector can be calculated as in Equations (21) and (22) below, respectively.

[Math. 21]

Rᵢ=∥X^{(i)T}{X−(XW−X⁽ⁱ⁾V₍ᵢ₎)X}X^{T}∥₂ (21)

[Math. 22]

Cⱼ=∥X^{T}{X−X(WX−H^{(j)}X₍ⱼ₎)}X₍ⱼ₎^{T}∥₂ (22)

For the above, when Rᵢ≤λᵣ, V₍ᵢ₎=0 is satisfied, and when Cⱼ≤λ_{c}, H^{(j)}=0 is satisfied.

If the upper and lower bounds can be calculated for the optimal condition values Rᵢ and Cⱼ, the data processing apparatus 10 described so far can be used for simultaneous extraction of C and R. An upper bound of Rᵢ is expressed as in Equation (23), and a lower bound of Rᵢ is expressed as in Equation (24).

[Math. 23]

R̅ᵢ̅=\tilde{R}ᵢ+G₍ᵢ₎⁽ⁱ⁾∥ΔV₍ᵢ₎∥₂∥F∥_{F}+∥G₍ᵢ₎∥₂∥ΔW∥_{F}∥F∥_{F} (23)

[Math. 24]

Rᵢ=\tilde{R}ᵢ−G₍ᵢ₎⁽ⁱ⁾∥ΔV₍ᵢ₎∥₂∥F∥_{F}−∥G₍ᵢ₎∥₂∥ΔW∥_{F}∥F∥_{F} (24)

In the above, F=XX^{T}. ˜Rᵢ is an optimal condition value immediately before entrance to the internal loop.

An upper bound of Cⱼ is expressed as in Equation (25), and a lower bound of Cⱼ is expressed as in Equation (26).

[Math. 25]

C̅ⱼ̅=\tilde{C}ⱼ+∥G∥_{F}∥ΔH^{(j)}∥₂F₍ⱼ₎^{(j)}+∥G∥_{F}∥ΔW∥_{F}∥F^{(j)}∥₂ (25)

[Math. 26]

Cⱼ=\tilde{C}ⱼ−∥G∥_{F}∥ΔH^{(j)}∥₂F₍ⱼ₎^{(j)}−∥G∥_{F}∥ΔW∥_{F}∥F^{(j)}∥₂ (26)

˜Cⱼ is an optimal condition value immediately before entrance to the internal loop.

System Configuration of Embodiment

Each component of the data processing apparatus 10 illustrated in FIG. 1 is a functional conceptual component and does not necessarily need to be physically configured as illustrated in the drawings. That is, a specific form of distribution and integration of functions of the data processing apparatus 10 is not limited to the form illustrated in the drawings, and all or some thereof can be distributed or integrated functionally or physically in any units according to various loads, and use situations.

Further, all or some of processing operations performed in the data processing apparatus 10 can be implemented by a CPU and a program analyzed and executed by the CPU. Further, each of the processing operations performed by the data processing apparatus 10 may be implemented as hardware by wired logic.

Further, all or some of the processing operations described as being performed automatically among the processing operations described in the embodiment can be performed manually. Alternatively, all or some of the processing operations described as being performed manually can be performed automatically using a known method. In addition, information including the processing procedures, control procedures, specific names, and various types of data or parameters described above and illustrated in the drawings can be appropriately changed unless otherwise specified.

Program

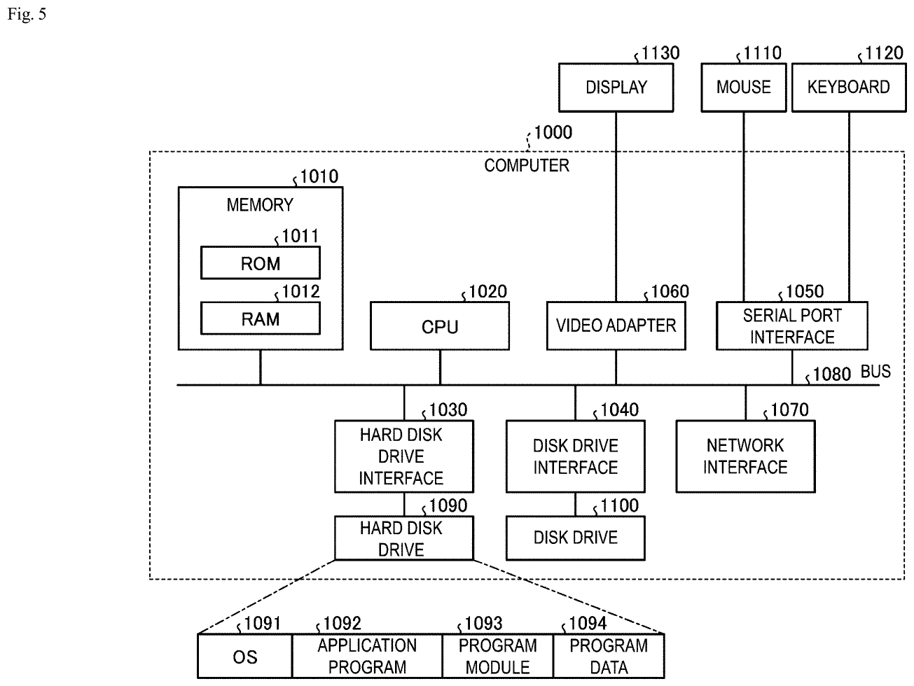

FIG. 5 is a diagram illustrating an example of a computer in which the data processing apparatus 10 is implemented by a program being executed. The computer 1000 includes, for example, a memory 1010 and a CPU 1020. Further, the computer 1000 includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and a program data 1094. That is, a program that defines each of the processing operations of the data processing apparatus 10 is implemented as the program module 1093 in which a code that can be executed by a computer 1000 has been described. The program module 1093 is stored in, for example, the hard disk drive 1090. For example, the program module 1093 for executing the same processing as that of a functional configuration in the data processing apparatus 10 is stored in the hard disk drive 1090. The hard disk drive 1090 may be replaced with a solid state drive (SSD).

Further, configuration data to be used in the processing of the embodiment described above is stored as the program data 1094 in, for example, the memory 1010 or the hard disk drive 1090. The CPU 1020 reads the program module 1093 and the program data 1094 stored in the memory 1010 or the hard disk drive 1090 into the RAM 1012 and executes the program module 1093 and the program data 1094, as necessary.

The program module 1093 and the program data 1094 are not limited to being stored in the hard disk drive 1090 and may be stored, for example, in a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). The program module 1093 and the program data 1094 may be read by the CPU 1020 from another computer via the network interface 1070.

Although the embodiment to which the invention made by the present inventor has been applied has been described above, the present invention is not limited by the description and the drawings that form a part of the disclosure of the present invention according to the present embodiment. That is, other embodiments, examples, operational techniques, and the like made by those skilled in the art based on the present embodiment are all included in a category of the present invention.

### REFERENCE SIGNS LIST

10 Data processing apparatus
11 Gram matrix calculation unit
12 Norm calculation unit
13 Parameter search unit
14 Lower bound calculation unit
15 Important matrix determination unit
16 Important matrix extraction unit
17 Important matrix updating unit
18 Optimal condition value calculation unit
19 Upper bound calculation unit
20 Calculation omission determination unit
21 Updating calculation unit
22 Convergence determination unit

1. A data processing method, comprising:
calculating norms of rows or columns of a gram matrix of given data;
calculating, in search of a hyperparameter, based on a norm of a row or column to be processed, a lower bound of a determination value of an optimal condition when a solution of a parameter vector corresponding to the row or column to be processed is a zero vector;
determining whether the row or column to be processed is important based on the lower bound, to extract the row or column that is determined to be important;
updating a parameter corresponding to the row or column that is determined to be important;
calculating an upper bound of the determination value of the optimal condition when the solution of the parameter vector corresponding to the row or column to be processed is the zero vector; and
determining whether parameter updating for the row or column to be processed is necessary based on the upper bound, to perform the parameter updating when the parameter updating is determined to be necessary.

2. The data processing method according to claim 1, wherein the determining whether the row or column to be processed is important includes determining, when the lower bound is larger than the hyperparameter, that the row or column to be processed corresponding to the lower bound is important, to extract the row or column.

3. The data processing method according to claim 1, wherein the determining whether parameter updating for the row or column to be processed is necessary includes determining, when the upper bound is equal to or smaller than the hyperparameter, that the parameter updating for the row or column to be processed is unnecessary, to omit the parameter updating.

4. A data processing apparatus configured to extract important rows or columns from matrix data, the data processing apparatus comprising:
first calculation circuitry configured to calculate norms of rows or columns of a gram matrix of given data;
second calculation circuitry configured to calculate, in search of a hyperparameter, based on a norm of a row or column to be processed, a lower bound of a determination value of an optimal condition when a solution of a parameter vector corresponding to the row or column to be processed is a zero vector;
first determination circuitry configured to determine whether the row or column to be processed is important based on the lower bound;
extraction circuitry configured to extract the row or column that is determined to be important by the first determination circuitry;
first updating circuitry configured to update a parameter corresponding to the row or column that is determined to be important;
third calculation circuitry configured to calculate an upper bound of the determination value of the optimal condition when the solution of the parameter vector corresponding to the row or column to be processed is the zero vector;
second determination circuitry configured to determine whether parameter updating for the row or column to be processed is necessary based on the upper bound; and
second updating circuitry configured to perform the parameter updating when the parameter updating is determined to be necessary by the second determination circuitry.

5. A non-transitory computer readable medium storing a data processing program for causing a computer to execute:
calculating norms of rows or columns of a gram matrix of given data;
calculating, in search of a hyperparameter, based on a norm of a row or column to be processed, a lower bound of a determination value of an optimal condition when a solution of a parameter vector corresponding to the row or column to be processed is a zero vector;
determining whether the row or column to be processed is important based on the lower bound, to extract the row or column that is determined to be important;
updating a parameter corresponding to the row or column that is determined to be important;
calculating an upper bound of the determination value of the optimal condition when the solution of the parameter vector corresponding to the row or column to be processed is the zero vector; and
determining whether parameter updating for the row or column to be processed is necessary based on the upper bound, to perform the parameter updating when the parameter updating is determined to be necessary.

6. The non-transitory computer readable medium according to claim 5, wherein:
the determining whether the row or column to be processed is important includes determining, when the lower bound is larger than the hyperparameter, that the row or column to be processed corresponding to the lower bound is important, to extract the row or column.

7. The non-transitory computer readable medium according to claim 5, wherein:
the determining whether parameter updating for the row or column to be processed is necessary includes determining, when the upper bound is equal to or smaller than the hyperparameter, that the parameter updating for the row or column to be processed is unnecessary, to omit the parameter updating.

8. The data processing apparatus according to claim 4, wherein:
the first determination circuitry is further configured to determine, when the lower bound is larger than the hyperparameter, that the row or column to be processed corresponding to the lower bound is important, to extract the row or column.

9. The data processing apparatus according to claim 4, wherein:
the second determination circuitry is further configured to determine, when the upper bound is equal to or smaller than the hyperparameter, that the parameter updating for the row or column to be processed is unnecessary, to omit the parameter updating.
